(19) United States
(12) Patent Application Publication
(10) Pub. No.: US 2026/0154692 A1
(43) Pub. Date: Jun. 4, 2026

(54) AUGMENTED CONTENT GENERATION WITH LANGUAGE MODEL FOR ASSISTING OPERATION OF SMART CART

(71) Applicant: Maplebear Inc., San Francisco, CA (US)

(72) Inventors: Brent Scheibelhut, Toronto (CA); Charles Wesley, San Diego, CA (US); Naval Shah, Toronto (CA); Mark Oberemk, Toronto (CA)

(21) Appl. No.: 18/964,277

(22) Filed: Nov. 29, 2024

(51) Int. Cl. G06Q 30/015; B62B 5/00; G06F 40/205; G10L 15/22; H04W 4/021

(52) U.S. Cl. CPC G06Q 30/015; B62B 5/0096; G06F 40/205; G10L 15/22; H04W 4/021

(57) ABSTRACT

A system receives real-time sensor data from sensors of a smart cart. The system identifies a triggering event based on the sensor data. The system obtains a template for the triggering event, wherein the template comprises instructions for generating suggestions for the user to augment smart cart operation. The system may obtain other contextual information, e.g., order data, user data, source data about a source location, etc. The system generates a prompt by modifying the template to include the sensor data or the contextual information. The system causes execution of the prompt by a language model, which outputs a response based on the prompt. The system generates augmented content including the suggestions for the user by parsing the response. The augmented content may be multimodal, combining multiple forms of data. The system transmits the augmented content for presentation to the user to augment operation of the smart cart.

### BACKGROUND

A smart shopping cart (also referred to as a “smart cart”) is a shopping cart that includes a computing system and one or more sensors such as cameras, weight scales, item scanners, etc., which aid the user whilst in-store. For example, the smart cart may help the user find items in a store, detect items placed in the cart, determine its own location within a store, present offers and other recommendations to the user, and handle checkout. The computing system mounted to the cart may have a display and input/output features so that the user can interact with the functionality of the cart. The computing system may also have a network connection to some central system to send and receive information for providing that functionality.

As a user is at a physical in-store location operating a smart cart, the user typically has various objectives to accomplish at the store. However, the user may have limited insight about the particular store. For example, the user may not know where particular items are located within the store, such that the user may pass a desired item without knowing. Or, in other examples, the user may forget to grab certain items on a list. Such limitations can create inexpediencies in servicing an order. Moreover, traditional shopping carts are solely mechanical, unable to provide any digital functionality to augment operation of the cart.

### SUMMARY

In accordance with one or more aspects of the disclosure, a system receives real-time sensor data from sensors of a smart cart. The system identifies a triggering event based on the sensor data. The system obtains a template for the triggering event, wherein the template comprises instructions for generating suggestions for a user to augment operation of the smart cart. The system may obtain other contextual information, e.g., order data, user data, source data about a source location, etc. The system generates a prompt by modifying the template to include the sensor data or the contextual information. The system causes execution of the prompt by a language model, which outputs a response based on the prompt. The system generates augmented content including the suggestions for the user by parsing the response. The augmented content may be multimodal, combining multiple forms of data. The system transmits the augmented content for presentation to the user to augment operation of the smart cart.

The augmentation of smart cart operation based on real-time sensing by the smart cart provides real-time utility to a picker servicing an order at a source location. For example, the system may leverage the real-time sensing to provide reminders to avoid inexpediency in servicing of an order. In other examples, the system may leverage historical data associated with a picker to help contextualize a new or infrequently visited source location. In other examples, the system may leverage the augmented content to provide on-the-fly updates relating to characteristics of the user's order, the source location, or other aspects relating to the smart cart operation. In other examples, the system may leverage an autonomous agent for automatically performing one or more actions, e.g., on behalf of the picker.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example smart cart, in accordance with one or more embodiments.

FIG. 4 is an illustrative flowchart of augmentation of smart cart operation via real-time sensing by the smart cart, in accordance with one or more embodiments.

FIG. 5 is a method flowchart of augmentation of smart cart operation via real-time sensing by the smart cart, in accordance with one or more embodiments.

### DETAILED DESCRIPTION

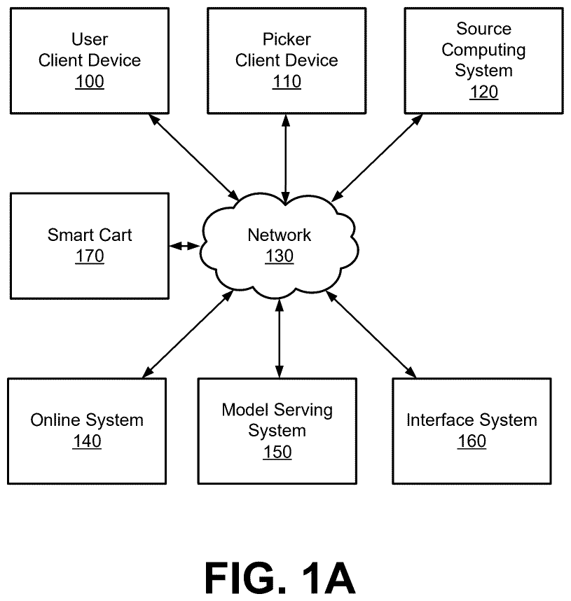

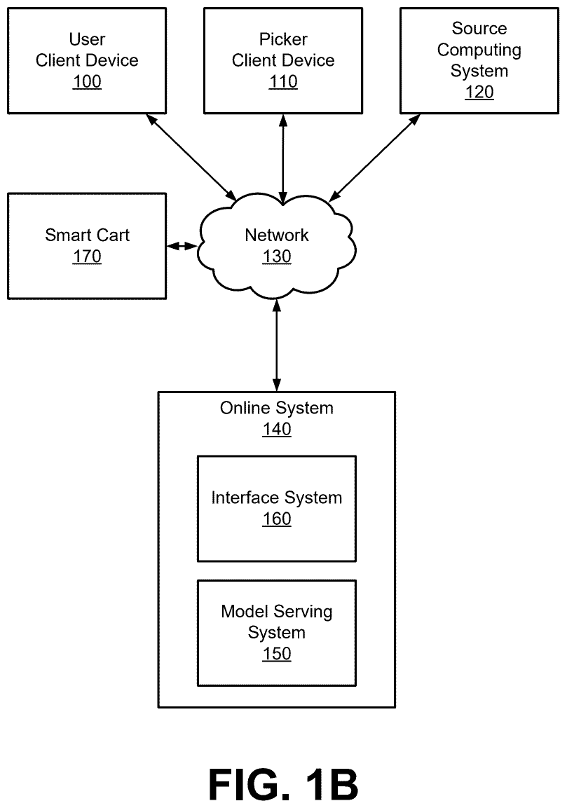

FIG. 1A illustrates an example system environment for an online system 140, in accordance with one or more embodiments. The system environment illustrated in FIG. 1A includes a user client device 100, a picker client device 110, a source computing system 120, a network 130, an online system 140, a model serving system 150, an interface system 160, and a smart cart 170. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with other components of the environment, e.g., the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered.

Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140.

The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with other components of the environment, e.g., the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker is another user that services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 may also provide navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart cart 170 being used by a user to collect items in a source location. For example, the smart cart may display content received from the online system and may receive data describing items that are collected by the user and stored in a storage area of the shopping cart. In some embodiments, the smart cart 170 may implement the picker client device 110 being operated by a picker collecting items within a source location. Similarly, the smart cart may be operated by a user within the source location collecting items for themselves.

The smart cart 170 is a shopping cart with a suite of digital components for intelligent operation of the smart cart 170. The smart cart 170 may include various sensors for monitoring operation of the smart cart 170. In one or more embodiments, the smart cart 170 may include one or more cameras for capturing image data. The cameras may be positioned to capture items placed into one or more baskets of the smart cart 170. In one or more embodiments, the smart cart 170 may include one or more acoustic sensors for capturing audio data. The acoustics sensors may be used to capture speech of the user operating the smart cart 170. For example, the user can ask questions, the audio of which can be captured by the acoustic sensors for analysis of the speech. In one or more embodiments, the smart cart 170 may include load sensors or other sensors for further measuring characteristics of items being obtained. The load sensors may measure a load on the one or more baskets over time. Other types of sensors may include item scanners, e.g., RFID scanners, barcode scanners, etc. In one or more embodiments, the smart cart 170 may also include a tracking system for tracking a location of the smart cart 170 within an environment of the store. Example embodiments of smart carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

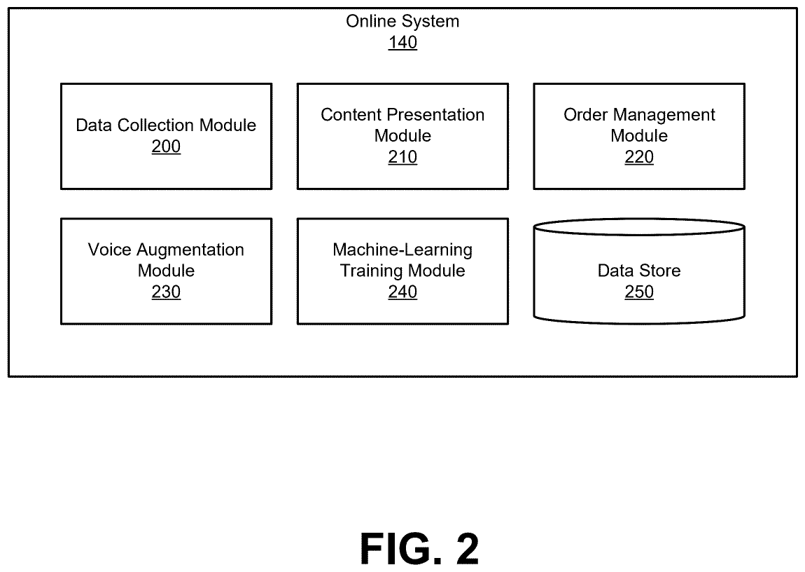

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, an augmentation module 230, a machine-learning training module 240, and a data store 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 250. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, past ordering history, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 may also collect past order servicing history of the picker, e.g., including information of items obtained, source locations visited, regions where the picker has delivered orders, etc. The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 250.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and identifies pickers based on picker data for notification of the orders for the pickers to select orders to service. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker accepts an order. The order management module 220 may notify the picker of the available order on the picker client device 110. The picker may choose to select from available orders. The order management module 220 may register the selection and provide full details of the selected orders.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 (or the smart cart 170) or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The augmentation module 230 generates augmented content for assisting pickers while at a source location. In one or more embodiments, the augmentation module 230 may generate augmented content for a user visiting a source location (according to the same principles described herein with respect to the picker). The augmentation module 230 may receive data (e.g., including real-time data) associated with the picker's visit of a source location. Based on the data, the augmentation module 230 may identify triggering events. The augmentation module 230 may store heuristics for identifying whether triggering events have occurred. For example, each triggering event may be associated with one or more triggers and logic for determining whether the triggering event has occurred based on detecting one or more of the triggers being present. For example, one triggering event may be detected as having occurred if the augmentation module 230 determines if any one of the triggers is detected.

In response to identifying a triggering event, the augmentation module 230 generates content for assisting the picker. The augmentation 230 leverages a language model (e.g., an LLM) to generate the content. To leverage the language model, the augmentation module 230 generates one or more prompts for execution on the language model based on the data associated with the picker's visit. The augmentation module 230 may maintain a plurality of prompt templates for each type of triggering event. For example, a triggering event is identified when the picker's location (e.g., as determined by a tracking system of a smart cart 170) enters one department of the source location (e.g., the deli of a grocery store). A prompt template may include instructions for generating a reminder of items on their list to be obtained from that department. The augmentation module 230 provides the prompts to a model serving system 150 for execution on the language model. The augmentation module 230 receives a response from the model serving system 150 following execution of the prompt on the language model. The augmentation module 230 may generate follow-on prompts based on the response, e.g., requesting clarity, requesting modifications to the response, etc., which are provided to the model serving system 150 for execution on the language model. The augmentation module 230 parses the one or more responses output by the language model to generate the augmented content for presentation to the picker. The augmentation module 230 may generate the augmented content comprising visual content, audio content, augmented-reality content, notifications, multimodal content, or some combination thereof.

The augmentation module 230 provides the generated augmented content to a device for presentation to the picker. In one or more embodiments, the augmentation module 230 may provide the augmented content to the picker's client device 110 for presentation. In other embodiments, the augmentation module 230 may provide the augmented content to the smart cart 170 for presentation. The augmentation module 230 may receive data following presentation of the augmented content. From the data, the augmentation module 230 may infer feedback related to the augmented content, e.g., whether the picker responded positively to the augmented content, or whether the picker ignored or responded negatively to the augmented content. For example, the augmented content may include suggesting actions to the picker to perform during their in-store visit. The augmentation module 230 may receive the real-time data (e.g., captured by sensors of the smart cart 170) to infer whether the picker adopted those suggested actions or ignored the suggested actions. Based on the detected feedback, the augmentation module 230 may generate prompts to provide additional augmented content, refined based on the feedback.

In one or more embodiments, the augmentation module 230 may leverage an autonomous agent for performing actions based on responses from the language model. For example, the augmentation module 230 may parse the responses from the language model to identify actions performable by the autonomous agent. Example actions may include automatically marking an item from a list or order as having been obtained, performing check-out for a picker, sending communications to other pickers based on communication history, etc.

The machine-learning training module 240 trains machine-learning models used by the online system 140. For example, the machine learning module 230 may train the item selection model, the availability model, or any of the machine-learned models deployed by the model serving system 150. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 240 generates the set of parameters (e.g., the particular values of the parameters) for a machine-learning model by “training” the machine-learning model. Once trained, the machine-learning model uses the set of parameters to transform inputs into outputs.

The machine-learning training module 240 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 240 may apply an iterative process to train a machine-learning model whereby the machine-learning training module 240 updates parameter values of the machine-learning model based on each of the set of training examples. The training examples may be processed together, individually, or in batches. To train a machine-learning model based on a training example, the machine-learning training module 240 applies the machine-learning model to the input data in the training example to generate an output based on a current set of parameter values. The machine-learning training module 240 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 240 updates the set of parameters for the machine-learning model based on the score generated by the loss function. For example, the machine-learning training module 240 may apply gradient descent to update the set of parameters.

In some embodiments, the machine-learning training module 240 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 240 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

In some embodiments, the machine-learning training module 240 trains the language model leveraged in generating augmented content, e.g., for assistance in operation of a smart cart during a source visit. To train the language model, the machine-learning training module 240 may obtain training data from historical sessions of picker's visits to various source locations. The machine-learning training module 240 may identify instances in the historical sessions where the picker may have been inexpedient in their visit. For example, the machine-learning training module 240 may map out the route taken by the picker in obtaining items for the visit. The route may capture wait times elapsed at varying points of the visit. From the route, the machine-learning training module 240 may infer instances of inexpediency. For example, if the picker revisited a department of the source location multiple times to grab different items (e.g., in one or more orders), then the machine-learning training module 240 may infer the revisit was an instance of inexpediency. In another example, the picker may have spent a substantial time waiting for service at another department due to more-than-average crowds at that moment. In yet another example, the machine-learning training module may infer an instance of expediency in the picker taking an inefficient route, e.g., going from one point to another, likely indicating that the picker was lost or confused about the location of things. The machine-learning training module 240 may also obtain picker preference data (e.g., preferred sources, delivering preferences, available timeframes to visit source locations, other preferences provided by the picker or inferred by the online system 140, or some combination thereof). The machine-learning training module 240 may transform the picker data into text format for input into the language model. The language model may reference the input picker data in generating the suggestions requested by the prompting.

In one or more embodiments, the machine-learning training module 240 may leverage feedback from the picker in refining the language model's outputs. The data collection module 200 may track the picker's response to suggestions presented in the augmented content. For example, the picker may adopt a suggestion provided in the augmented content, or may ignore or reject the suggestion. In another example, the picker may provide feedback to the suggestion, e.g., poor suggestion, good suggestion, etc. The machine-learning training module 240 may use the feedback to tune the language model to refine its outputs. For example, the machine-learning training module 240 may craft positive reinforcement training examples with positive feedback to the augmented content and negative reinforcement training examples with negative feedback to the augmented content. The machine-learning training module 240 may tune (i.e., retrain) the language model to bias towards the positive reinforcement training examples and to bias against the negative reinforcement training examples, i.e., tuning the language model to output responses more in step with the positive reinforcement training examples and less in step with the negative reinforcement training examples.

The data store 250 stores data used by the online system 140. For example, the data store 250 stores user data, item data, order data, and picker data for use by the online system 140. The data store 250 also stores trained machine-learning models trained by the machine-learning training module 240. For example, the data store 250 may store the set of parameters for a trained machine-learning model on one or more non-transitory, computer-readable media. The data store 250 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 240 may further train parameters of the machine-learned model based on data specific to the online system 140 stored in the data store 250. As an example, the machine-learning training module 240 may obtain a pre-trained transformer language model and further fine tune the parameters of the transformer model using training data stored in the data store 250. The machine-learning training module 240 may provide the model to the model serving system 150 for deployment.

### Smart Cart

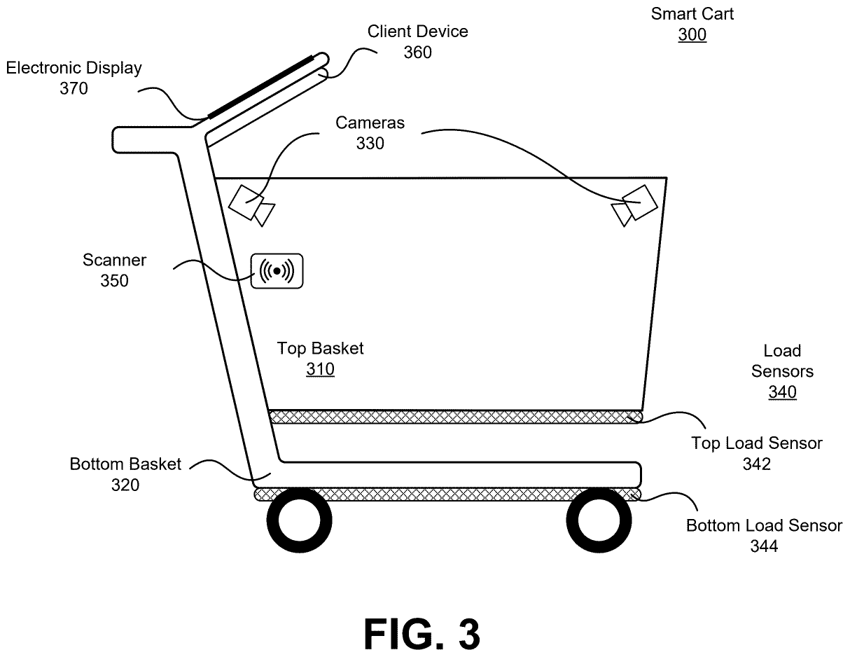

FIG. 3 illustrates a smart cart 300, in accordance with some embodiments. The smart cart 300 is an embodiment of the smart cart 170. The smart cart 300 may be operated by a user in a store location to obtain and purchase items listed for sale in the store location. In one or more embodiments, the smart cart 300 includes a top basket 310 and a bottom basket 320 atop a set of wheels. The smart cart 300 further comprises a plurality of cameras 330, load sensors 340, a scanner 350, a client device 360, and an electronic display 370. Alternative embodiments may include more, fewer, or different components from those illustrated in FIG. 3, and the functionality of each component may be divided between the components differently from the description below. For example, the smart cart 300 may further include other input or output devices, e.g., microphones or speakers. In other examples, the smart cart 300 may include a location sensor for tracking a location of the smart cart 300 within an in and around a store location. In yet other examples, the smart cart 300 may include different number of baskets, or each basket may be further subdivided into compartments, etc. Additionally, each component may perform their respective functionalities in response to a request from a human, or automatically without human intervention.

The baskets store items obtained by a user whilst traversing the store location and prior to checking out. As shown in FIG. 3, the baskets may include, e.g., a top basket 310 and a bottom basket 320. In other embodiments, there may be any other number of baskets. In additional embodiments, a basket may be subdivided into multiple compartments. In yet additional embodiments, the baskets may be disparately dimensioned, e.g., one basket may be shallow and positioned near the handle, whereas another basket may be deep and cylindrical for storing long skinny items.

The cameras 330 capture image data of an interior of the baskets. In general, the cameras 330 capture image data to identify and detect items placed in the smart cart 300. The captured image data may include photos or video. In the embodiment shown in FIG. 3, the cameras 330 are positioned internal facing for the top basket 310.

In other embodiments, each basket may include one or more of the cameras 330 positioned to identify and detect items placed in the respective baskets. In yet other embodiments, a subset of the baskets may include one or more cameras, whereas other baskets do not have dedicated cameras. In still other embodiments, cameras may be positioned to be in view of one or more baskets, i.e., having a field of view that encompasses the one or more baskets.

The load sensors 340 measure a weight of items placed in the baskets. Each load sensor generates load data indicating a measure of weight or mass of items placed in each respective basket over time. For example, the load data may be zeroed when the basket is emptied, and, when a user places a first item into the basket, the load sensor may record the change in load atop the load the sensor as the load data. The load data may be time series data of the total load, or change in load. In other embodiments, the load data may indicate a load per item placed into the smart cart 300 recorded at a particular timestamp during the in-store visit.

In one or more embodiments, each basket may be coupled to a load sensor. In other embodiments, a subset of baskets may be outfitted with load sensors, whereas others do not have dedicated load sensors. As shown in FIG. 3, there is a top load sensor 315 for the top basket 310 and a bottom load sensor 325 for the bottom basket 320. In some embodiments, a load sensor may include one or more load sensing devices, e.g., for sensing the loads on different portions of a basket.

In some embodiments, the smart cart 300 includes the scanner 350. In such embodiments, the scanner 350 may scan uniquely tagged items. The scanner 350 may record the entering of the uniquely tagged items as scan data. The scanner 350 scans a signature of each item placed in the smart cart 300. The signature is a unique identifier for each item, e.g., a barcode, a RFID signature, QR code, etc. The range of the scanner 350 may toggled to only detect items placed into the smart cart 300, while not registering nearby external items as entering the cart.

In one or more embodiments, the scanner 350 is a radio-frequency identification (RFID) scanner. Accordingly, items available at the store location are tagged with RFID chips. The RFID chips may use active emission or passive emission. To be an active emitter, the RFID chip includes a power source (e.g., a battery) that enables the RFID chip to emit a distinct radio-frequency signature. To be a passive emitter, the RFID chip does not have its own power source. Rather, the RFID chip receives power from the RFID scanner's electromagnetic waves, thereby inducing a current in the RFID chip's antenna.

In other embodiments, the scanner 350 may be a barcode scanner. In such embodiments, each item may be tagged with a barcode. The store system may log a database of items with corresponding barcodes, such that the scanner 350 may capture light reflected off the barcode to determine the unique barcode signature of the item. In one or more related embodiments, the scanner 350 may be a quick-response (QR) code scanner. Similar to the barcode scanner, each item is tagged with a QR code that is unique to the item. The scanner 350 captures an image of the QR code and compares the detected QR code to a database of QR codes associated with items to identify an item that has entered the smart cart 300.

In some embodiments, the smart cart 300 may include a location sensor for tracking of a position of the smart cart in the store location. For example, the location sensor may be Bluetooth enabled, RFID enabled, GPS enabled, etc. The location sensor may also include an accelerometer, an inertial measurement unit, a magnetometer, wheel sensors, etc. The location sensor can leverage such devices to determine the cart's position, velocity, acceleration, etc. Other technologies for tracking may also be implemented. For example, the store location may be outfitted with a camera system to capture images of the smart carts as they traverse around the in-store environment.

The client device 360 is a computing device that analyzes the data captured by the smart cart 300. The client device 360 may perform functionality of the requesting user client device 100 and the fulfillment user client device 110. In the context of a requesting user utilizing the smart cart 300, the client device 360 may present content that would be presented to the requesting user client device 100, e.g., content recommending various items. In the context of a fulfillment user utilizing the smart cart, the client device 360 may present content that would be presented to the fulfillment user client device 110, e.g., an order assigned to the fulfillment user and comprising a list of items and their positions in the store location. Accordingly, the client device 360 may be communicatively connected to an online system (e.g., the online system 140, via the network 130).

In general, the client device 360 analyzes the data captured by the smart cart 300 to determine content for the user of the smart cart 300. For example, the client device 360 may, based on sensor data, detect items obtained by the user and currently in the smart cart 300 (also referred to as “obtained items,” or “items in cart”). The client device 360 may also track or receive a location of the smart cart 300 in the in-store environment. The client device 360 may also apply a recommendation model to the sensor data or the location of the smart cart 300 to determine one or more items to recommend to the user during the in-store visit (also referred to as “recommended items,” or “item recommendations”). In some embodiments, the recommendation model further considers item information (e.g., stored by the online system 140) or other contextual data relating to the in-store visit (e.g., user data, in-store visit data, etc.). In some embodiments, the recommendation model may be locally stored on the client device 360. In other embodiments, the recommendation model is stored on an online system (e.g., the online system 140). In such embodiments, the client device 360 provides data to the online system which applies the recommendation model to return the recommended items. The client device 360 may further provide navigation instructions to obtain the recommended items, which may be based on the cart's location and each recommended item's location.

The electronic display 370 provides an interface for a user of the smart cart 300. The electronic display 370 may be configured to provide content to a user and may also be configured to receive user input. The electronic display 370 may include other input or output devices, e.g., a microphone or a speaker. The electronic display 370 may be a component of the client device 360.

### Augmentation of Smart Cart Operation

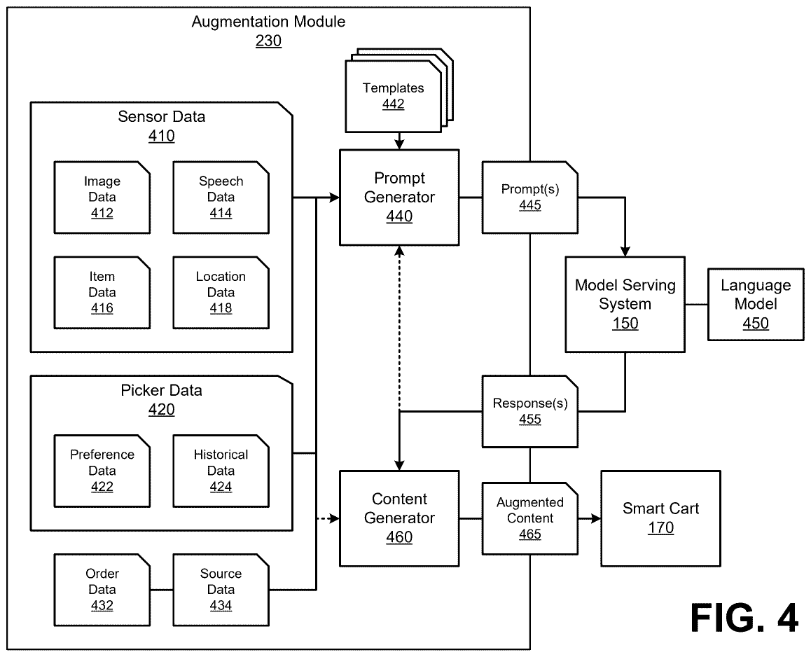

FIG. 4 is an illustrative flowchart of augmentation of smart cart operation via real-time sensing by the smart cart, in accordance with one or more embodiments. In other embodiments, augmentation of smart cart operation via real-time sensing by the smart cart may entail additional, fewer, or different steps than those illustrated in FIG. 4. Furthermore, the principles described in FIG. 4 can be cross-applicable to smart cart operation by a general user, instead of a picker. In such embodiments, data associated with the user may be leveraged in providing the augmented content.

The augmentation module 230 generates augmented content 465 for augmenting smart cart operation in real-time. The augmentation module 230 may obtain real-time sensor data from the smart cart 170. Example sensor data may include image data 412, speech data 414, item data 416, location data 418, other data characterizing operation of the smart cart 170, or some combination thereof. The image data 412 may include images of items obtained by the smart cart 170 (or another client device), e.g., of items obtained by the picker. The speech data 414 may include audio data measured by acoustic sensors and analyzed for speech commands by the picker. The item data 416 may include any information on items obtained by the picker, e.g., as detected through one or more item scanners or via the image data 412. The location data 418 may include information on a position of the smart cart 170 within the source location. Other example sensor data 410 may include movement data describing motion of the smart cart 170, other forms of user input, e.g., via an interactive interface presented by a device of the smart cart 170, other data measured by sensors of the smart cart 170, or some combination thereof. The augmentation module 230 may further obtain picker data 420 describing characteristics of the picker operating the smart cart 170. Example picker data 420 may include preference data 422, historical data 424, or some combination thereof. The preference data 422 may include preferences provided by the picker or inferred by the online system 140 (i.e., subject to opt-in by the picker). The historical data 424 may include information on past orders serviced by the picker. The augmentation module 230 may also obtain order data 432 or source data 434 associated with at least the source location that the picker is presently at. The order data 432 may include information on orders being serviced by the picker at the source location. The source data 434 may include information on the source location, e.g., inventory of items, position of items in the source location, other characteristics related to items, wait times at one or more departments, position of departments, etc.

A prompt generator 440 generates one or more prompts 445 for execution by a language model 450, e.g., via the model serving system 150. The prompt generator 440 may initially identify whether any triggering event has occurred based on the real-time sensor data 410 or the source data 434. The prompt generator 440 may maintain a set of heuristics for identifying the triggering events. Upon detecting a triggering event, the augmentation module 230 automatically assesses whether augmented content may be generated and presented to the user to augment the picker's real-time operation of the smart cart. If a triggering event is detected, the prompt generator 440 may leverage a set of templates 442 associated with the type of triggering event detected as a basis for forming the prompt 445. The template may include a generic set of instructions for generating one or more suggestions to the picker in response to the triggering event. The prompt generator 440 may modify a template 442 based on the sensor data 410, the picker data 420, the order data 432, the source data 434, or some combination thereof to yield the prompts 445. The prompt generator 440 serves the prompts 445 to the model serving system 150 for execution on the language model 450. The model serving system 150 returns any responses 455 to the prompts 445 back to the augmentation module 230. The augmentation module 230 may parse the responses 455 to identify whether to craft any follow-on prompts 445. The follow-on prompts are subsequently served to the model serving system 150 for execution on the language model 450 to generate additional responses. In some embodiments, the responses 455 of the language model are in multimodal form (e.g., text, audio, images, video, navigation instructions, etc.).

A content generator 460 of the augmentation module 230 parses the responses 455 to generate augmented content 465. In one or more embodiments, the augmentation module 230 outputs suggestions in the form of quoted text. In such embodiments, the content generator 460 may generate the augmented content 465 from the quoted text. For example, the content generator 460 may generate a text notification with the quoted text for display on a client device (e.g., the picker's client device or the client device on the smart cart 170). In other embodiments, the content generator 460 may generate a speech audio byte based on the quoted text. An audio speaker (e.g., of the client device or of the smart cart 170) may present the speech audio byte to the user. The content generator 460 may further leverage the sensor data 410, the picker data 420, the order data 432, the source data 434, or some combination thereof in generating the augmented content 465. For example, the content generator 460 may append images of items in an order to be included in the augmented content 465, e.g., as a reminder to the picker to obtain these items in the current department before leaving. Presentation of the augmented content in real-time to the picker's operation of the smart cart is key. If the augmented content is presented too late, then the augmented content's utility would be moot. For example, a reminder to the picker to obtain all items in an order located in one department (e.g., the fresh produce department) would be ill-timed and potentially detrimental to the picker's expediency, if the reminder is presented after the picker has already left the fresh produce department.

In some example implementations, the augmentation module 230 may help a picker to contextualize a new (or infrequently visited) source location. In such implementations, the augmentation module 230 may detect, as a triggering event, whether the picker has visited a location no more than some threshold. The augmentation module 230 may retrieve a template such as:
“Based on [Picker]'s service history, please identify similarities between [Current Source Location] and [Past Source Locations].”
   The bracketed portions are populatable fields. The augmentation module 230 may populate information specific to this session into the populatable fields to craft the prompt. Upon execution by the language model 450, the augmentation module 230 may receive responses such as:
“This is like the store on Avenue Road that you were at on Tuesday, but the Deli Counter is in the center of the store instead of the back corner.”
   or:
“This store doesn't usually put cookies on endcaps, so don't count on finding them there like you have in past shops.”
   The augmentation module 230 may parse such responses to generate a relevant text notification to the picker for personalized contextualization.

In some example implementations, the augmentation module 230 may help a picker with real-time suggestions for improving the picker's servicing of an order. The augmentation module, 230 may detect, as a triggering event, the picker arriving in a department. The augmentation module 230 may retrieve a template such as:
“Based on the [Current Wait Time] for this [Department A] , please identify whether there are other actions that can be taken before obtaining [Items] at [Department A].”
   The augmentation module 230 may populate the relevant information, e.g., the real-time wait time provided by the source computing system 120 and the real-time tracking of the smart cart 170. Upon execution by the language model 450, the augmentation module 230 may receive responses such as:
“The line for the Deli Counter is extremely long right now. You may want to shop other items first and then return to the Deli Counter at a later time.”
   The augmentation module 230 may parse this response to generate a relevant text notification to the picker. The augmentation module 230 may, alternatively, generate a speech audio byte to present to the picker.

In some example implementations, the augmentation module 230 may, as augmented content, present real-time suggestions related to checkout or delivery. The augmented module 230 may detect, as a triggering event, that the picker has obtained all items in an order and is ready to checkout and deliver the order, e.g., based on real-time item data indicating items obtained in the smart cart 170. The augmentation module 230 may retrieve a template such as:
“Given the [Order], please generate step-by-step packing instructions for [Items].”
   The augmentation module 230 may further append other order information or contextual information in the prompt. Upon execution by the language model 450, the augmentation module 230 may receive responses such as:
“Remember to place the eggs on top of other items within the bag.”
   In another example, the augmentation module 230 may retrieve a template such as:
“Given the [Order], please identify some important reminders from the delivery instructions.”
   Upon execution by the language model 450, the augmentation module 230 may receive responses such as:
“1. Remember the gate code is ‘4598’.
2. Please knock loudly.
3. Please drop bags off at door.”
   The augmentation module 230 may parse such responses to generate a relevant text notification to the picker. The augmentation module 230 may, alternatively, generate a speech audio byte to present to the picker.

In some example implementations, the augmentation module 230 may provide, as augmented content, responses to a picker's inquiries. In such implementations, an acoustic sensor, e.g., implemented on the smart cart 170 or the picker client device 110, may capture the audio data of the picker speaking (i.e., subject to the picker's opt-in for audio recording). The audio data may be parsed (e.g., with other voice identification algorithms) to identify speech by the picker. For example, the picker may be inquiring on the location of a particular item:
“Where can I find Dish Soap?”
   Identifying an inquiry in the speech may be a triggering event. In response, the augmentation module 230 may identify a template such as:
“Based on this inquiry: [Text of Speech], please generate a response based on the following contextual information.”
   The text of the speech by the picker would be input into the populatable field. Upon execution by the language model 450, the augmentation module 230 may receive responses such as:
“The Dish Soap can be found in Aisle 12 on the right-hand side in the middle of the aisle.”
   The augmentation module 230 may parse such responses to generate a relevant text notification to the picker. The augmentation module 230 may, alternatively, generate a speech audio byte to present to the picker.

In some example implementations, the augmentation module 230 may evaluate multimodal inquiries or may provide multimodal suggestions. For example, the augmentation module 230 may receive image data from a picker's client device 110 or the smart cart 170. The picker may also speak an inquiry, captured by an acoustic sensor, e.g., on the picker's client device 110 or the smart cart 170. In one or more examples, the image data may capture a live, real-time feed of an aisle in the source location. Concurrently, the picker may inquire:
“Where can I find the Lucky Charms in this aisle?”
   The augmentation module 230 may generate a prompt indicating the inquiry and may further include other contextual information, e.g., from the source data 434. The augmentation module 230 may serve the prompt to the language model 450 for execution. Based on the response, the augmentation module 230 may generate, as the augmented content, augmented reality content, wherein virtual content is appended onto the image data. In the above example, the augmentation module 230 may generate an animation or some other manner of pinpointing the desired item in the image data.

In some example implementations, the augmentation module 230 may leverage an Autonomous agent to automate performance of actions. The Autonomous agent may parse the responses 455 to identify actions that can be taken, e.g., on behalf of the picker. In some embodiments, the Autonomous agent may be leveraged to provide automated responses to a user's inquiries to the picker, i.e., in conversations between the picker and the user. For example, the user may provide a modification to their order:
“I've changed my mind, could you remove the broccoli from my order?”
   The augmentation module 230 may identify, as a triggering event, that the user has requested a modification. The augmentation module 230 may generate a prompt to the language model 450, leveraging a template such as:
“Based on this inquiry: [Text of Speech], please identify any action items that need to be taken and please generate a response to the inquiry.”
   Upon execution by the language model 450, the augmentation module 230 may receive responses such as:
“Actions:
1. Return the broccoli.
2. Modify order to remove broccoli.
Response:
Got it, I'll remove broccoli from your order.”
   The Autonomous agent may be leveraged to perform one or more of the actions. In the above example response, the Autonomous agent may automatically modify or to interact with the order being fulfilled by the picker, e.g., to remove an item from the order. The augmentation module 230 may inform, via augmented content, the picker to perform any other action items, e.g., physically returning an obtained item to its original location.

### Example Methods

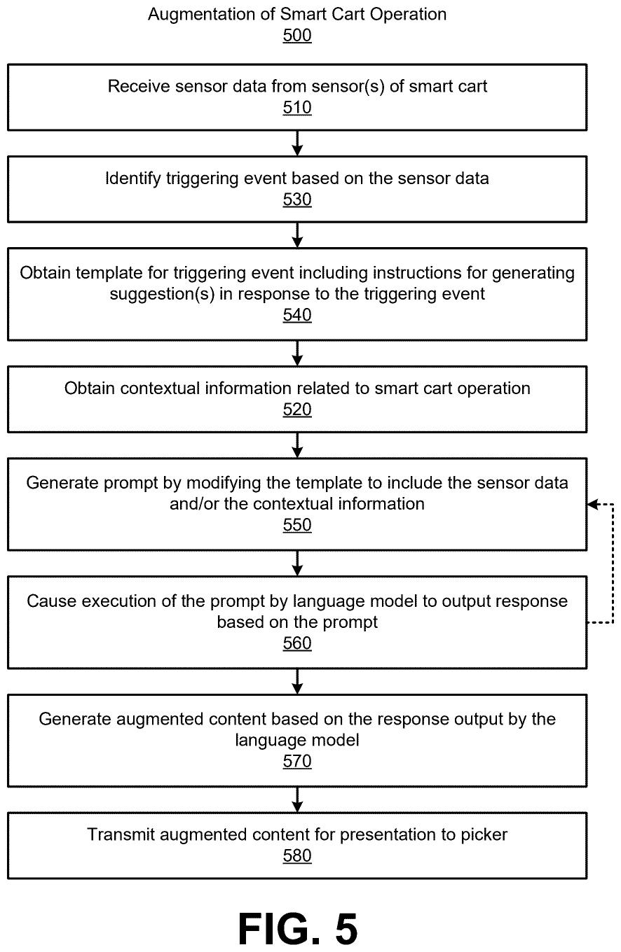

FIG. 5 is a method flowchart of augmentation of smart cart operation 500 via real-time sensing by the smart cart, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The system receives 510 real-time sensor data from sensors of a smart cart. The sensor data may include various types of data measured by sensors of the smart cart. For example, the sensor data may include image data, audio data, location data, item data, etc.

The system identifies 520 a triggering event based on the sensor data. The system may evaluate a plurality of types of triggering events. Each triggering event may be identified according to a set of one or more triggering criteria and logic associated with the triggering criteria. As such, the system identifies, based on the sensor data, whether the triggering criteria are satisfied to identify the triggering event as having occurred.

The system obtains 530 a template for the triggering event including instructions for generating suggestions for the picker to augment smart cart operation. The system may maintain templates for each type of triggering event. The template may include populatable fields for inputting information relevant to the current operation of the smart cart.

The system obtains 540 contextual information related to the smart cart's operation, e.g., order data, picker data, source data about a source location, etc. Such data may be stored by the system or provided by one or more components of the environment. For example, the order data may specify items to be obtained, delivery instructions, etc. The picker data may include preferences by the picker, historical data of past orders serviced by the picker, etc. The source data may include information specific to the source location, e.g., inventory on items, layout of the source location (i.e., where departments or items are located), etc.

The system generates 550 a prompt by modifying the template to include the sensor data or the contextual information. The system may populate fields in the template based on the sensor data or the contextual information. In some embodiments, the system may append additional information to the prompt to further inform the response generation by the language model. In some embodiments, the prompt may be multimodal, i.e., including data of two or more different forms.

The system causes 560 execution of the prompt by a language model, which outputs a response based on the prompt. The language model may be trained on corpus(es) of text to perform natural language processing tasks. In some embodiments, the system may train or tailor the language model to a particular individual by feeding the language model data on the picker, e.g., preference data, conversations by the picker, historical data, etc. The response may also be multimodal, i.e., including data in two or more different forms.

The system generates 570 augmented content including the suggestions for the picker by parsing the response. The augmented content may be multimodal, combining multiple forms of data. The augmented content provides suggestions to the picker to augment operation of the smart cart. For example, the system may generate speech audio bytes for suggestions output in the response by the language model.

The system transmits 580 the augmented content for presentation to the picker to augment operation of the smart cart. The augmented content may be presented by the smart cart or the picker's client device. For example, visual content may be displayed on a display. Or as another example audio content may be presented by an audio speaker.

In some embodiments, the system receives feedback from the picker in response to the augmented content. The picker may either adopt or reject the suggestions presented in the augmented content. Based on the picker's reaction, the system may generate reinforcement training examples for tuning (i.e., retraining) the language model.

In some embodiments, the system may leverage an autonomous agent to perform actions based on the response by the language model. The system may parse the response to identify any actions performable by the autonomous agent. If there's a performable action, the autonomous agent may automatically perform the action. Example actions may include modifying an order being serviced by the picker, responding to a conversation with a user, etc.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

1. A method, performed at a computer system comprising a processor and a computer-readable medium, comprising:
receiving sensor data from one or more sensors of a smart cart in operation by a picker at a source location;
identifying a triggering event from a plurality of types of triggering events based on the sensor data;
retrieving a template associated with the identified triggering event, wherein the template comprises instructions for generating one or more suggestions for the picker to augment operation of the smart cart;
obtaining contextual information associated with operation of the smart cart by the picker;
generating a prompt by modifying the template comprising the instructions to include the sensor data and the contextual information;
transmitting, to a model serving system, the prompt for execution by a language model;
receiving, from the model serving system, a response output by the language model;
generating augmented content including visual content including text describing one or more suggestions for the picker by parsing the response output by the language model; and
causing display of the augmented content on an electronic display of the smart cart during operation of the smart cart.

2. The method of claim 1, wherein identifying the triggering event comprises:
identifying, based on the sensor data, whether each of one or more triggering criteria is satisfied; and
based on identifying that each of the one or more triggering criteria is satisfied, identifying that the triggering event occurred.

3. The method of claim 1, wherein the template comprises one or more populatable fields, and wherein generating the prompt comprises inputting information from the sensor data or the contextual information into each populatable field.

4. The method of claim 1, wherein generating the prompt comprises generating the prompt to include multimodal data.

5. The method of claim 1, wherein the language model is configured to output the response to include multimodal data, and wherein generating the augmented content comprises generating the augmented content to include multimodal data.

6. The method of claim 1, wherein generating the augmented content comprises:
parsing the response to identify one or more suggestions for the picker; and
generating a speech audio byte for each suggestion.

7. The method of claim 1, further comprising:
identifying one or more actions performable by an autonomous agent from the response output by the language model, wherein one action performable by the autonomous agent includes modifying an order being serviced by the picker; and
modifying, via the autonomous agent, the order being serviced by the picker.

8. The method of claim 1, wherein the language model is trained by:
obtaining preference data describing one or more preferences by the picker; and
training the language model with the preference data to bias generating suggestions to account for the one or more preferences by the picker.

9. The method of claim 8, further comprising:
receiving feedback from the picker in response to the augmented content either adopting or rejecting at least one suggestion presented in the augmented content;
generating a reinforcement training example based on the feedback from the picker; and
retraining the language model with at least the reinforcement training example.

10. The method of claim 1, further comprising:
obtaining historical data describing one or more past orders serviced by the picker;
wherein identifying the triggering event comprises identifying that the picker has visited the source location less than a threshold number of instances based on the historical data;
wherein generating the prompt comprises generating the prompt to include instructions to contextualize the source location to other source locations from the historical data of the picker; and
wherein generating the augmented content comprises generating one or more suggestions describing a layout of the source location as compared to layouts of the other source locations.

11. The method of claim 1,
wherein receiving the sensor data comprises receiving location data from a tracking system, wherein the location data tracks location of the smart cart in the source location;
wherein identifying the triggering event comprises identifying that the picker is entering or leaving one department of the source location based on the location data;
wherein generating the prompt comprises generating the prompt to include instructions to provide reminders for one or more items to be obtained in the department; and
wherein generating the augmented content comprises generating one or more reminders to obtain the one or more items before leaving the department.

12. The method of claim 1,
wherein receiving the sensor data comprises receiving audio data from an acoustic sensor, wherein the audio data captures speech by the picker;
wherein identifying the triggering event comprises identifying an inquiry by the picker in the audio data;
wherein generating the prompt comprises generating the prompt to include the inquiry by the picker and instructions to generate a response to the inquiry; and
wherein generating the augmented content comprises generating one or more responses to the inquiry of the picker.

13. The method of claim 12,
wherein receiving the sensor data further comprises receiving image data from a camera;
wherein generating the prompt further comprises generating the prompt to include the image data; and
wherein generating the augmented content comprises generating virtual content to append to the image data.

14. A non-transitory computer-readable storage medium storing instructions that, when executed by a processor, cause the processor to perform operations comprising:
receiving sensor data from one or more sensors of a smart cart in operation by a picker at a source location;
identifying a triggering event from a plurality of types of triggering events based on the sensor data;
retrieving a template associated with the identified triggering event, wherein the template comprises instructions for generating one or more suggestions for the picker to augment operation of the smart cart;
obtaining contextual information associated with operation of the smart cart by the picker;
generating a prompt by modifying the template comprising the instructions to include the sensor data and the contextual information;
transmitting, to a model serving system, the prompt for execution by a language model;
receiving, from the model serving system, a response output by the language model;
generating augmented content including visual content including text describing one or more suggestions for the picker by parsing the response output by the language model; and
causing display of the augmented content to on an electronic display of the smart cart during operation of the smart cart.

15. The non-transitory computer-readable storage medium of claim 14, wherein identifying the triggering event comprises:
identifying, based on the sensor data, whether each of one or more triggering criteria is satisfied; and
based on identifying that each of the one or more triggering criteria is satisfied, identifying that the triggering event occurred.

16. The non-transitory computer-readable storage medium of claim 14, wherein the template comprises one or more populatable fields, and wherein generating the prompt comprises inputting information from the sensor data or the contextual information into each populatable field.

17. The non-transitory computer-readable storage medium of claim 14, wherein generating the prompt comprises generating the prompt to include multimodal data.

18. The non-transitory computer-readable storage medium of claim 14, wherein generating the augmented content comprises:
parsing the response to identify one or more suggestions for the picker; and
generating a speech audio byte for each suggestion.

19. The non-transitory computer-readable storage medium of claim 14, the operations further comprising:
identifying one or more actions performable by an autonomous agent from the response output by the language model, wherein one action performable by the autonomous agent includes modifying an order being serviced by the picker; and
modifying, via the autonomous agent, the order being serviced by the picker.

20. A system comprising:
a processor; and
a non-transitory computer-readable storage medium storing instructions that, when executed by the processor, cause the processor to perform operations comprising:
receiving sensor data from one or more sensors of a smart cart in operation by a picker at a source location;
identifying a triggering event from a plurality of types of triggering events based on the sensor data;
retrieving a template associated with the identified triggering event, wherein the template comprises instructions for generating one or more suggestions for the picker to augment operation of the smart cart;
obtaining contextual information associated with operation of the smart cart by the picker;
generating a prompt by modifying the template comprising the instructions to include the sensor data and the contextual information;
transmitting, to a model serving system, the prompt for execution by a language model;
receiving, from the model serving system, a response output by the language model;
generating augmented content including visual content including text describing one or more suggestions for the picker by parsing the response output by the language model; and
causing display of the augmented content on an electronic display of the smart cart during operation of the smart cart.
